(19) United States
(12) Patent Application Publication
(10) Pub. No.: US 2008/0065590 A1
(43) Pub. Date: Mar. 13, 2008

(54) LIGHTWEIGHT QUERY PROCESSING OVER IN-MEMORY DATA STRUCTURES

(75) Inventors: Pablo Castro, Redmond, WA (US); Andrew J. Conrad, Sammamish, WA (US); Jose A. Blakely, Redmond, WA (US); Colin Joseph Meek, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/470,940

(22) Filed: Sep. 7, 2006

(51) Int. Cl. G06F 17/30

(52) U.S. Cl. 707/2

(57) ABSTRACT

Lightweight query processing for in-memory or cache memory data structures, such as DataSet, is provided. Prior to executing a query over an in-memory data structure, a query processor determines whether any benefits can be obtained by first optimizing the query execution strategy. Additionally, one or more bail out points can be applied to the optimization analysis to further enhance query execution speed for circumstances where optimization is unlikely to provide significant performance benefits. The lightweight query processing techniques can be supported in any framework for processing or formulating queries of in-memory data structures, such as language integrated query (LINQ) queries.

### TECHNICAL FIELD

The subject invention relates to processing queries over data stores. More particularly, the invention relates to a lightweight query processing techniques for processing queries over in memory data structures.

### BACKGROUND

Traditional processing of queries over a persistent data store, such as a relational database, e.g., to extract one or more subsets of data from the data store, has evolved to apply optimization algorithms to the execution of queries. Such optimization algorithms can provide significant performance gains especially where the amount of data in the data store is very large, and where the query is relatively complex. This is because with each new piece of data placed in the data store, which might be implicated by a query, there are increased time costs in terms of increased disk input/output (I/O) time and increased computational time. The disk I/O time cost is associated with accessing the underlying disk of the data store to retrieve the data, and the computational time cost is associated with analyzing the relevance of the accessed data to the query at hand. Accordingly, it stands to reason that for data stores including millions, or more, records (e.g., rows) in the data store, these time costs become quite significant, even debilitating for some applications, and thus, it has been shown that some advance work with respect to determining an optimal strategy for querying the data store can save significant query processing time.

As shown by the flow diagram of FIG. 10, traditionally, with a typical request 1000 for data, such as a query, from a traditional persistent data store, such as a relational database, a query processor analyzes the data at 1010 to determine whether any optimizations can be performed to make the process for returning the results of the request more efficient. If so, then a plan for returning the results, e.g., a query execution plan, is optimized at 1020 and then, execution of the request is carried out according to the optimized plan at 1030. The results of the request for data are then returned at 1040.

Today, with such persistent data stores, much of the optimizations of step 1020 are performed with respect to the number of anticipated data reads, since as mentioned, disk I/O is expensive in terms of time consumed. Such traditional optimization algorithms thus place a significant emphasis on the costs associated with disk I/O. Examples of other factors that have been considered in the query optimization context for a persistent store are the quantity (size) of the data and the selectivity (e.g., distribution) of the data, which in turn can influence the number of disk reads as well.

The benefits of optimizing query execution in the context of a persistent store are known, as generally illustrated by FIG. 11 comparing optimization curve 1100 with brute force processing curve 1110. It is noted that curves 1100 and 1110 of FIG. 11 show linear versus logarithmic degradation, which is specific to particular patterns, not a characteristic of all optimized queries. For example, a “filter” operator will change from linear to logarithmic when the optimizer changes from a sequential scan to an index scan (assuming that the index has log n average lookup time, e.g. a B-tree index as used in many databases). FIG. 11 thus shows that performing optimizations for certain kinds of query processing saves significant time for even a relatively small number of rows greater than or equal to N, due to the significant cost of disk reads with such persistent data stores. With each new row added to the data store, for instance, as shown by curve 1110, for certain classes of query optimizing scenarios, the cost of a brute force analysis (e.g., access and analyze all) of the data increases in a linear manner.

In contrast, as demonstrated by optimization curve 1100, while optimizing has greater upfront cost C, generally speaking, again in the context of certain classes of query optimizing scenarios, if N or more rows are implicated by a query, then optimization gains can be quickly observed in terms of reduced query processing time. Moreover, since the data store is persistent, many optimizations on the data in the underlying data store can be performed prior to receiving any query. If the optimizations on the data have already been performed prior to receiving a query, then the upfront cost C to optimize the query is even smaller, and the performance benefit of optimization is manifest.

Since I/O reads take a significant amount of the blame for making brute force approaches slow, as mentioned, query processing optimizations for persistent stores have taken into account a minimized number of I/O reads as a primary factor when forming an efficient execution plan, which leads to the observed query processing time decreases associated with curve 1100. While these optimizations function well in the context of a persistent store, there is also an evolving context in which an application, service, etc. may query against an in-memory data structure, e.g., cached locally, so that the application, service, etc. need not resort directly to a persistent data store for processing of a query. For instance, when an application, service, etc. wishes to collect data from a plurality of external data stores to form a local collection of data, existing APIs allow the collection of the data, and caching of such a local collection so that local queries can be executed against the local collection.

Today, however, there are no existing optimizations for processing queries over such transient, in-memory collections of data, perhaps due to the assumption that really fast I/O access to cache memory outweighs any optimization performance gains. More particularly, there are currently no heuristic optimizations based on schema/auxiliary data structures information applied to improve optimization of query processing over in-memory collections of data. As the size of these ephemeral, cached collections of data increases along with the ever-increasing capacity, complexity and power of data storage and processing, however, there has arisen a clear need for optimizations tailored to such in-memory query processing scenarios. Accordingly, there is a need for a query processing component that optimizes the execution of queries against in-memory data structures, and that addresses the above-identified deficiencies and others in the current state of the art of query processing.

### SUMMARY

In consideration of the above-described deficiencies of the state of the art of query processing, the invention provides lightweight query processing for in-memory or cache memory data structures, such as DataSet. In various non-limiting embodiments, prior to executing a query over an in-memory data structure, the lightweight query processor of the invention determines whether any benefits can be obtained by first optimizing the query execution strategy. Additionally, one or more bail out points can be applied to the optimization analysis to further enhance query execution speed for circumstances where optimization is unlikely to provide significant performance benefits. The lightweight query processing techniques of the invention can be supported in any framework for processing queries of in-memory data structures or any framework for formulating queries, such as language integrated query (LINQ) queries.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The lightweight query processing for in-memory data structures in accordance with the present invention is further described with reference to the accompanying drawings in which:

FIG. 1 illustrates exemplary consolidation of data in an in-memory data structure in accordance with the invention;

FIGS. 2A and 2B illustrate exemplary optimization based on indexing for an in-memory data structure in accordance with the invention;

FIG. 3 shows exemplary, non-limiting pseudo-code for a query in accordance with various examples presented herein pertaining to the present invention;

FIG. 4 illustrates an exemplary, non-limiting flow diagram showing the process for receiving a query against an in-memory data structure, such as a DataSet, in accordance with the invention;

FIGS. 5A and 5B illustrate side by side examples of queries for regular DataSets and typed DataSets, respectively, for various non-limiting implementations of the invention;

FIG. 6 illustrates a flow diagram showing the exemplary embodiments of the lightweight query processing techniques of the invention;

FIG. 7 is a block/flow diagram illustrating exemplary processes for the lightweight query processing of the invention in the context of a non-limiting LINQ implementation;

FIGS. 8A to 8C illustrate exemplary pseudo-code demonstrating the processing stages of a query and the difference between executing query code directly with default LINQ mechanism and executing query code according to the lightweight query processing of the invention;

FIG. 9 illustrates exemplary aspects of the operational performance of the invention in the presence of one or more bail out points;

FIGS. 10 and 11 show prior art techniques for optimizing queries in the context of persistent data stores, illustrating how such optimization techniques do not apply to the in-memory data structure context;

FIG. 12 is a block diagram representing an exemplary non-limiting networked environment in which the present invention may be implemented;

FIG. 13 is a block diagram representing an exemplary non-limiting computing system or operating environment in which the present invention may be implemented;

FIGS. 14A to 19B illustrate exemplary ways in which similar interface code can be provided to achieve similar or equivalent objective(s) of any interface(s) in accordance with the invention.

### DETAILED DESCRIPTION

### Overview

As mentioned in the background in the context of persistent data stores, to gain the performance benefits associated with fewer disk reads, query processing optimization algorithms have primarily focused in the past on how to minimize disk reads. In contrast, no such query processing optimizations have been applied to the context of in-memory data structures, perhaps due to the assumption that much higher access speeds obviate the need for optimization. Yet, merely because optimizations based on I/O reads for a persistent data store do not generally apply to cache storage does not mean that performance gains are not possible through optimization of query processing against such locally cached collections of data, particularly where significant data manipulation is implicated by a query.

Accordingly, the invention provides systems and methods for optimizing query processing over in-memory data-structures in a lightweight manner. In consideration of the different factors that affect performance in a cache setting, the invention determines optimal query execution based on the resulting time constraints imposed by optimization.

In various non-limiting embodiments, the lightweight query processor of the invention first estimates, or determines heuristically, whether any optimization benefits can be obtained by optimizing the query for the underlying data set of cache storage. If not, then the query is executed without any optimization. If so, such optimizations are performed before performing the query, providing an overall performance benefit as compared to performing no optimization. While there is an upfront cost to determining whether any optimization benefits are possible, such cost is minimal compared to the total cost that might otherwise result where a query implicates complex operations against a sizable data store. Additionally, one or more bail out points can be applied to the optimization analysis of the invention to further enhance performance where it becomes unlikely that optimization will provide any performance benefit.

In an exemplary, non-limiting embodiment, the lightweight query processing of the invention is provided in connection with querying over in-memory data structures with language integrated query (LINQ) support.

### Lightweight Query Processing

There is a large class of applications that support, as a primary mode of operation, queries over a data source, or more commonly, over multiple data sources (such as databases), bringing the data from the multiple data sources to the client system, and then performing heavy data manipulation functions on the client system on behalf of the user. A concrete example of such application class is financial applications that allow analysts to do “what-if”or “what-now” analyses and related simulations interactively, wherein the financial data is drawn, at any given moment, from a variety of sources for repeated analyses while varying a single parameter.

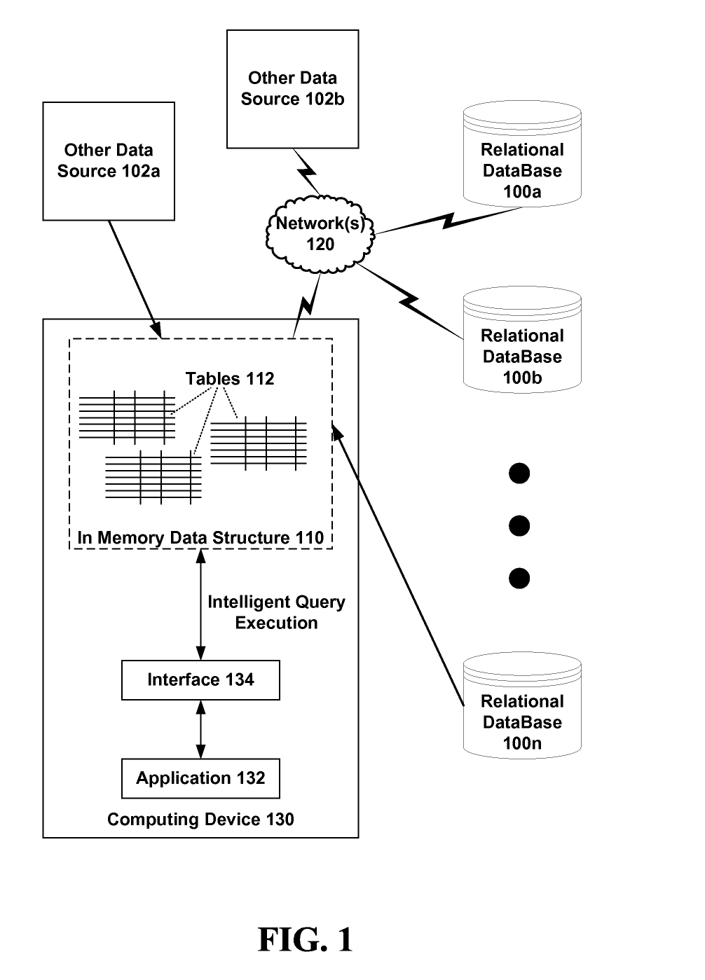

For instance, as shown in FIG. 1, a computing device 130 may include an application, service, computing object, etc. 132, which may seek to perform a query across a plurality of data sources via an interface 134. Thus, initially, the data over which the query is to be run is consolidated for convenience into a local in-memory data structure 110, consolidating certain subsets of data from any of relational databases 100a, 100b, . . . , 100n, or other data sources 102a, 102b, etc. For instance, other data source 102a might be an extensible markup language (XML) file located within the network on which computing device 130 resides, or some other data source 102b from which the data is retrieved via one or more external network(s) 120. The data from any of relational databases 100a, 100b, . . . , 100n may also either be extracted from a local database server or via network(s) 120.

Generally, in such scenarios, in-memory data structure 110 is organized to appear as a data structure in its native format. For instance, in-memory data structure 110 may appear as relational data, e.g., arranged as tables 112 from the perspective of the application 132, with rows and columns much in the same way that relational databases organize data, so that queries can be formulated in much the same way.

Once the data is consolidated locally as in-memory data structure 110, queries in general can be executed quickly due to fast memory access, even when taking a brute force approach. However, the invention recognizes that some intelligent optimization of query execution can still reap benefits, especially when the amount of data stored in data structure 110 is large. Thus, the lightweight query processing techniques of the invention are provided for such situations for more efficient querying. In this regard, the optimization techniques of the invention are not “heavyweight” (computationally intensive) as optimization techniques are with respect to persistent data stores. As described in the background, heavyweight computation upfront for persistent data stores can avoid a lot of time consuming data accesses in such context. However, such “heavyweight” optimization techniques are not justified in the context of in-memory data structures because memory access is comparatively much faster.

Microsoft's .NET Framework has introduced ADO.NET as a data-access API for programming against data of various sources in .NET applications. Among other things, ADO.NET introduced the DataSet, which is an example of the above-described in-memory data structure 110. In this regard, DataSet is an in-memory cache that retains the relational shape of the data it receives by representing data as a set of DataTable objects and related support constructs such as relationships. The DataSet has deep support for data-binding and change tracking, so the graphical user interface (GUI) frameworks for both Windows and Web applications can easily integrate with DataSet and greatly simplify the job of displaying and managing changes in data.

For many applications that download large amounts of data into local memory and then perform heavy manipulation and rich display of that data, DataSet is thus a good choice. Accordingly, in exemplary, non-limiting embodiments of the invention, lightweight query processing is enabled for applications making use of DataSet data structures.

While DataSet may be a good choice for such scenarios requiring heavy manipulation of locally stored data, as discussed above, currently there are no optimizations performed when querying over an in-memory data structure, such as a DataSet. In fact, when heavy manipulation of the data is required, or when the data is voluminous, such heavy analysis over the data (or better termed “rich query over data”) can implicate operations that are extremely slow when using simplistic strategies to search and relate the pieces of information contained in a data structure such as the DataSet. An example of this is a simple “join” operation where data from two tables in a DataSet is correlated based on user-provided criteria; the typical or “default” way of performing such a join operation is by performing a “nested-loop join,” which has quadratic algorithmic complexity, causing drastic slowdowns as the number of rows in the input tables increase.

The performance difference between a brute-force approach and the use of a lightweight query processor are not just of minor benefit. Rather, the advantages of lightweight query processing are noticed very quickly in applications that deal with even small amounts of data where often the algorithmic complexity demanded by a query can benefit from optimization. In more extreme cases, the lightweight query processing of the invention can make scenarios possible that would be otherwise effectively impossible due to time critical constraints.

The following illustrative scenarios show some exemplary performance gains achieved in accordance with the invention. For instance, in the presence of a pre-existing index, simple filters over a DataTable can be orders of magnitude faster than a sequential scan/filter over tables as small as 1000 rows.

Thus, one possible optimization to be performed is to create one or more in-memory index structures that correspond to the in-memory data structure. Common index structures include tree data structures such as B-trees, red-black trees, etc, hash-tables, or other tables built from the data in the in-memory data structure, and they enable algorithms to quickly target data which is required as part of query processing. Picking the number 79 out of a hat with the numbers 1 to 100 in the hat (analogous to the original data) is always more difficult than finding the number 79 in a list ordered from 1 to 100 (analogous to an index).

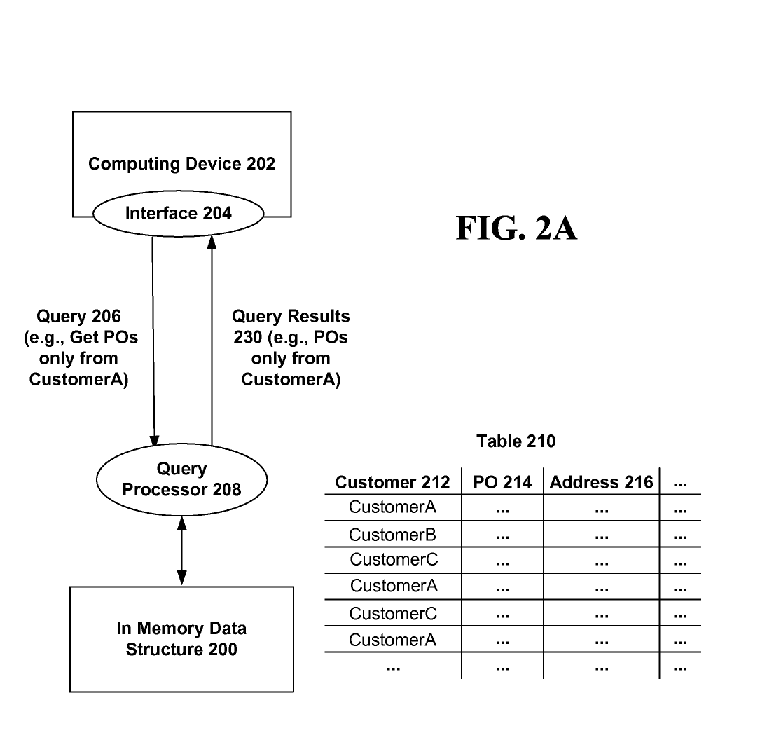

Thus, in one embodiment, of the invention, a determination is made as to whether a query will benefit from one or more indexing operations, e.g., whether a pre-existing index might benefit query execution. For instance, as shown in FIG. 2A, a computing device 202, pursuant to a request for data from an application, service or the like, consolidates data from a plurality of data sources (not shown) into in-memory data structure 200. Then, the computing device 202 originates a query 206 via interface 204, and query 204 is intercepted by query processor 208 prior initiating execution of the query 206 over in-memory data structure 200. In this regard, the data stored in in-memory data structure 200 may include one or more tables 210, having rows and columns, much like traditional relational data structures. For instance, in the example, random customer order data is collected having columns customer 212, purchase order number 214, address 216, etc. The rows in turn represent an individual order with customer specific data.

Thus, in one embodiment of the invention, as shown in FIG. 2B, whenever a query 206 is received by query processor 208, query processor 208 determines whether one or more in-memory index structures 220 exist, or should be created that correspond to the in-memory data structure. For instance, index 220 might reorder the customers in column customer 212′ so that data (purchase order information 214′, addresses 216′, etc.) associated with a particular customer, e.g., customerA, can be quickly retrieved since the location of customerA data is known due to the advance ordering of customer data in index 220. It should be clear that indexing is but one optimization that can be applied to queries, and that others, such as those referred to below, may also be implemented and/or combined with indexing to achieve more optimal query execution of in-memory data structures.

For another example that illustrates the benefits of optimization of query execution in accordance with the invention, for joins, the difference between brute-force and a more sophisticated approach such as hash-joins, merge-joins or index-lookup-joins is apparent even with a small number of rows, e.g., 5 times faster with a 1000 rows×10 rows join, and then grows very fast with the size of the inputs, e.g., 370 times faster for millions of rows. Thus, in another non-limiting embodiment of the invention, the invention considers optimizations such as hash-joins, merge-joins or index-lookup-joins prior to initiation of a brute-force query execution plan to determine whether any of such optimizations will significantly improve performance of the execution of the query.

For filters over an in-memory data structure, in exemplary, non-limiting implementations of the invention, instead of applying a brute force filter which loops over a DataTable.Rows collection and uses an “if” check to see if any given row meets the filter criteria, the lightweight query processor of the invention considers one or more of the following execution strategies prior to initiating the query: (A) Use of a LINQ query using a brute-force implementation provided by LINQ, (B) Use of a query processor with no indexes, though indexes are created on-demand and included as part of the operation, (C) Use of a query processor with an index over column(s) used in the filter predicate, (D) Use of the DataTable.Select method with a DataSet filter expression and (E) Use of the DataTable.Select method with a DataSet filter expression with an index over column(s) used in the filter predicate. These optional optimizations may be combined with these and other optimization algorithms for filtering in-memory data structures as well.

For joins (two way) over in-memory data structures, such as DataTable Objects, in exemplary, non-limiting implementations of the invention, instead of applying a brute force join which employs a straightforward nested-loop join for the case of joining two in-memory data structures in accordance with the invention, the lightweight query processor of the invention considers one or more of the following execution strategies prior to initiating the query as potential optimizations: (A) LINQ join that uses comprehensions syntax to create a query with to “from” clauses and the join condition in the where clause, (B) hash-join using a Dictionary <K, T> for hashing, (C) index-loop join, without indexes (indexes are created on demand and accounted for as part of the query), (D) index-loop join, with pre-existing indexes, (E) merge join without indexes (indexes are created on demand and accounted for as part of the query), (F) merge join with pre-existing indexes or (G) nested-loop join. These optional optimizations may be combined with these and other optimization algorithms for querying in-memory data structures as well. Similar join strategies can be employed for multiple-way joins by extending the optimization techniques for 2-way joins indicated above. For instance, a 3-way join can be created by repeating a 2-way join twice.

In exemplary, non-limiting implementations of the optimization algorithms of the invention, a query is analyzed for any one or more of the following properties: (1) the complexity of the query (in general, extremely complex queries are more likely to benefit from optimization than simple queries), (2) the availability of auxiliary data structures that can aid the efficiency with which queries are executed (e.g., hash tables, indexes, etc.) and/or (3) pattern matching, i.e., whether one or more portions of a query match a pre-defined class of query structures, or query templates, generally known to benefit from optimization.

In addition to the lack of internal capabilities of in-memory data structures, such as DataSets, to perform data operations in a smart way, there is the issue of choosing how queries are formulated. Thus, in an exemplary non-limiting implementation of the invention, using Microsoft LINQ project (language-integrated query), the invention enables the formulation of queries directly from host programming language(s), as opposed to requiring queries to be formulated in a native query language, such as SQL. Thus, LINQ provides a framework for creating data structure-based representations of queries for processing. Advantageously, a LINQ implementation of the invention provides a well-integrated infrastructure for query formulation and representation that spans programming languages and .NET Framework library components. In accordance with the invention, in order to support LINQ, DataSet is implemented in a way that ties in with the LINQ framework and execution methods are provide in LINQ that take advantage of DataSet capabilities.

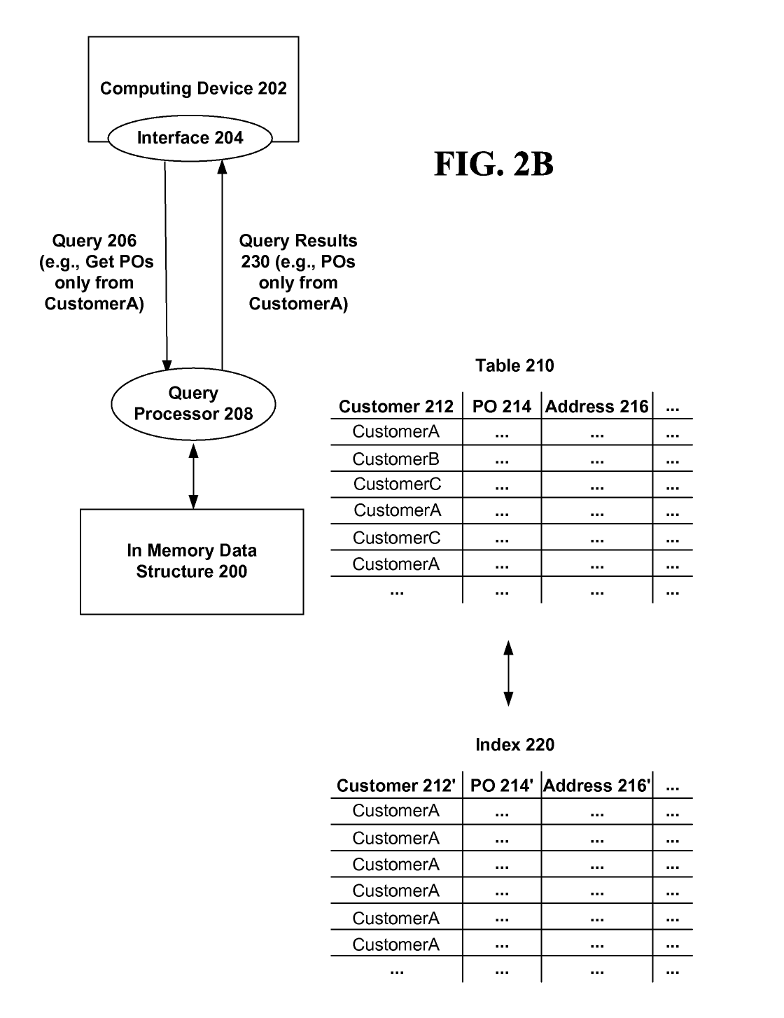

An exemplary use of LINQ over DataSet is as follows. For instance, if a user has created an in-memory table of SalesOrderHeader (containing sales orders) and an in-memory table of SalesOrderDetail (containing the line items for each sales order), and the user wants to obtain a list of each purchase of products that happened through the online store, along with the date when the purchase happened, how many were bought on each occasion and which orders carry those purchases, the user would be able to formulate the query against a DataSet including those in-memory tables using LINQ directly. An exemplary LINQ query for such a scenario is illustrated in the exemplary pseudo-code 300 of FIG. 3.

Not only is the query 300 easier to formulate syntactically when compared to the procedural version that a user would have had to write, but also, in the vast majority of cases, the DataSet lightweight query processing infrastructure of the invention executes the query significantly faster due to the advantageous use of specialized execution strategies, e.g., leveraging indexes that might be present in the DataSet against which the query is executed.

Thus, as described above, the invention introduces a lightweight query processing infrastructure for in-memory data structures, e.g., for DataSet, which is designed to be effective when compared to direct execution of code without analysis. Additionally, the integration of DataSet with LINQ provides a beneficial entry point for users into the query processing capabilities of the invention. Both regular DataSet and typed-DataSet classes are LINQ-enabled in one implementation of the invention. In this respect, the invention introduces support for efficient query processing of in-memory data structures, such as DataSet structures, that may or may not contain indexes. Two main challenges that were addressed in order to enable the above-described lightweight query processing include implementation of a programming interface design and the overhead trade-offs involved with the optimization algorithms. As mentioned, since in-memory data structures have different storage characteristics than persistent relational data stores, the tradeoffs are correspondingly very different.

With respect to the programming interface design, while it is possible to do so, it is relatively undesirable to introduce a completely new query language or query-building API in order to enable query over in-memory data structures, such as DataSet. Thus, in one implementation, the design uses LINQ to let users formulate queries in their host language and then execute them against DataSet.

With respect to overhead tradeoffs, since the data is already in memory, in theory, and as assumed in the past, the data can be queried by using simple brute-force algorithms, such as regular scans and nested-loop joins, which, depending on the nature of the data and the query, might in an of themselves be sufficient to execute a query quickly. Thus, in one aspect, the query processing infrastructure of the invention is “lightweight” enough that its overhead does not become greater than the benefit offered by the optimization.

In order integrate the optimization of query execution and the performance of queries with LINQ, in one embodiment, the DataSet implements the standard query pattern required by LINQ, including all of the standard query operators that operate over sets.

While it is technically possible to hook-up DataSet with the standard query operators and let those operators handle all queries against DataSet, the performance implication of doing so could severely hurt overall application performance and even make certain scenarios unpractical (see above for comments around performance). To mention a few specific examples:

With respect to the Filter operator, the default implementation without the invention will perform a linear scan, which will have linear slowdown that is ideal for the case where no additional information is available; however, in the presence of a pre-existing index (e.g., formed as part of a previous query, explicitly created, or created in the background when queries against DataSet are not being performed), an index-lookup could be performed, greatly speeding up the query (log n instead of linear).

With respect to the Join operator and explicit join syntax, the default implementation of LINQ uses a variation of hash-join that is order-preserving. While this is a fine execution strategy for small data sets, preserving order might cause the system to hash a less than ideal table (i.e., the largest table), which can severely affect resource utilization in some cases. Additionally, if indexes are present in the DataSet, a merge-join or an index-lookup join could be performed in accordance with the optimizations of the invention, instead of a hash-join, yielding even more performance benefits.

With respect to the Join operator and implicit joins, join can be implicitly formulated through the use of multiple “from” clauses, e.g., when using query comprehensions in VB or C#, or through the use of the SelectMany operator when using sequence operators syntax. In such a case, LINQ by default executes the query as a nested-loop join assuming a predicate that forces correlation between the tables. The more general case is to consider SelectMany as a “cross apply” in SQL terms. In this regard, the complexity of nested-loop joins is quadratic, resulting sometimes in unacceptable slowdowns for all but the smaller sets of rows. The advantage of the invention in such a case is clear: a lightweight query processor can detect a certain set of joins expressed implicitly and translate them into actual join operators.

With respect to the Sort operator, the default implementation of LINQ always has to sort the input in the Sort operator. Since DataSet may have indexes available to it, however, the enhanced implementation provided in accordance with the invention can leverage such an index if it was present and compatible, effectively eliminating the sort time (or, more accurately, pro-rating it across all the uses of the index).

Thus, in various non-limiting embodiments of the invention, instead of using the default implementation provided by the LINQ framework for the standard query operators, DataSet overrides the operators and provides its own version of a query execution plan, if and when appropriate, which is designed to take advantage of additional information and execution algorithms available to DataSet.

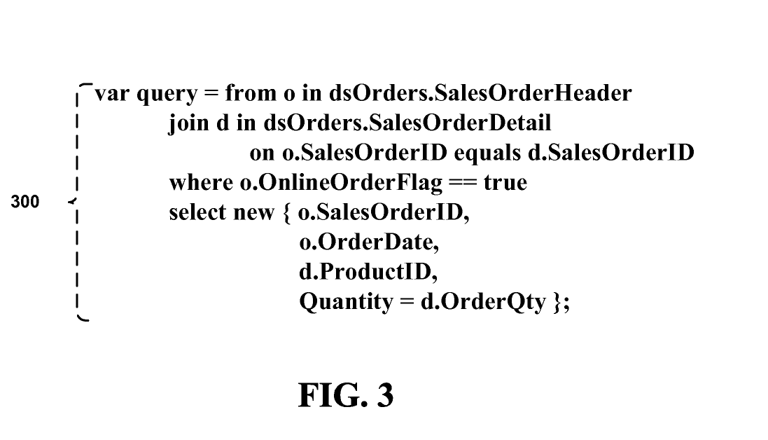

As illustrated by the exemplary non-limiting flow diagram of FIG. 4, to implement custom DataSet handling of query operators, first, at 400, the expression trees are received from the host language at runtime. These expression trees are a data structure-based description of a query that is uniform across all LINQ-enabled languages. Then, at 410, the expression trees are analyzed and processed (discussed in more detail below). At 420, once the expression trees have been analyzed and processed, they are compiled and executed. The result at 430 of executing a query against DataSet is a sequence of values.

The actual shape of a result-set can vary in complexity. Specifically, the result set can be a sequence of any one or more of DataRow objects, Complex custom or system objects and Scalars.

With respect to DataRow objects, in the absence of operators that affect the shape of the input (such as projection), the output is a set of DataRow objects that exist in the original input DataTable object(s). These DataRow objects are not copies, but the same objects, so their values are equated with the values in the underlying DataTable objects.

With respect to complex custom or system objects, by using operators, such as projection and grouping, values can be extracted from the input rows and turned into CLR objects of various kinds. The transformation process is typically guided by user-provided code that takes rows as input and yields instances of custom types on the output.

With respect to scalars, similar to the above, the transformation functions that take rows as input can choose to yield scalars, in which case the result is a sequence of scalar values, e.g., a sequence of integers.

The invention also includes support for turning LINQ queries into DataTable objects. The ToDataTable( ) operator, for instance, can be applied to a LINQ query and will cause the query to be executed and a DataTable object to be returned. The DataTable schema is generated based on the shape of the enumeration type of the input sequence.

As mentioned, the invention also provides enhanced usability with typed-DataSet, i.e., in addition to regular DataSets, the .NET Framework and Visual Studio support the concept of “typed” DataSets. These are code-generated classes that are produced based on a schema provided by the user. The schema specifies which tables are present in a given typed-DataSet, as well as the column names and data-types for each table. With this information, the system produces subtypes of the DataSet, DataTable and DataRow types that have members corresponding to the indicated tables and column names and types. This greatly improves usability of DataSets in general, particularly in the context of LINQ.

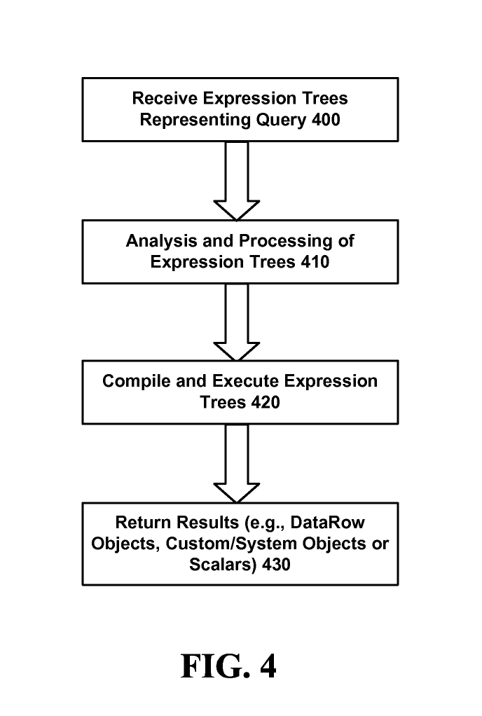

For example, given a DataTable “customers” that has CompanyName and State columns, a query to list all of the companies in the state of Washington might look like the exemplary pseudo-code 500 of FIG. 5A using regular DataSets whereas, with typed-DataSets, the query might look like the exemplary pseudo-code 510 of FIG. 5B. It can be observed that query 510 is significantly more simple than query 500 and also has much less infrastructure code, such as the “Field<>( )” accessor.

Accordingly, with a LINQ interface in place as described above, DataSet can now receive queries represented by expression trees. In order to execute them efficiently when there is opportunity for optimization, the lightweight query processing infrastructure of the invention is provided.

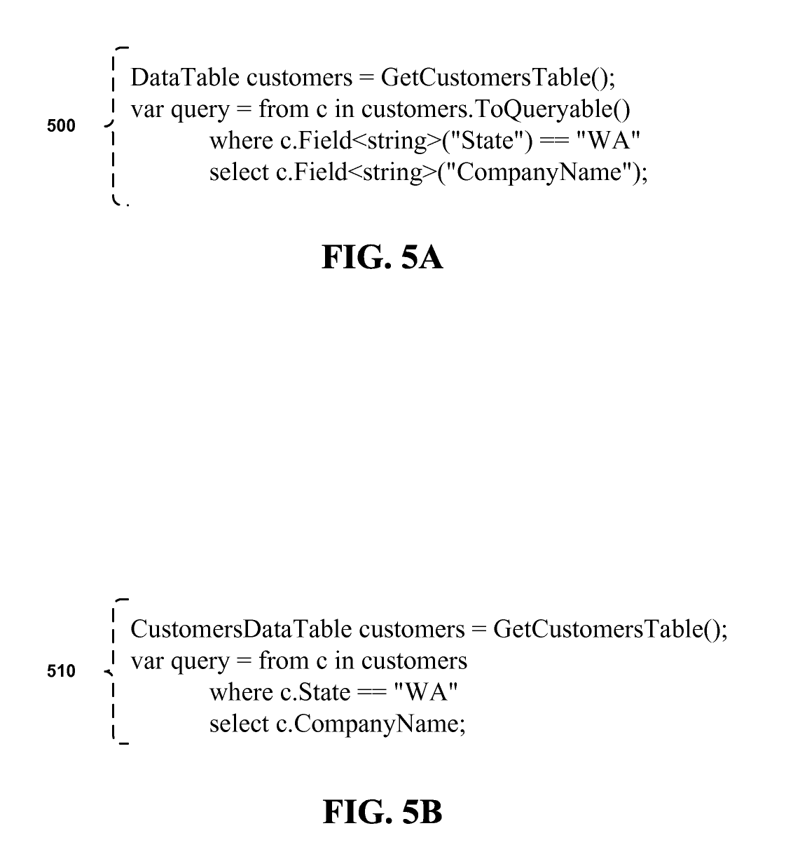

The high-level process implemented by the lightweight query processor of the invention is shown in the exemplary, non-limiting flow diagram of FIG. 6. At 600, the query, represented as an expression tree, is input into the query processor. At 610, the query processor will perform a quick pass over the expression trees to determine at 620 whether there are elements of the tree that are beneficial candidates for optimization.

If no candidates were found, then at 630, the expression tree is compiled into executable code using the native facilities provided by the LINQ libraries and executed at 640. Note that this means that no query execution engine is required, i.e., the expression tree that represents the query fully describes how to execute it in terms of a set of built-in operators that are executed according to the default methods. The tree can be directly compiled into executable code and executed.

If there are candidate areas of the tree at 620, then at 650, those areas of the tree are further analyzed to decide an execution path. The analysis may include both heuristic and/or cost-based algorithms that decide which is the best execution strategy. The execution strategy decided by the optimization phase is convertible to calls to a set of operators that are part of the implementation, i.e., nodes in the query expression tree are replaced with new nodes that include calls to the specialized operators, resulting in a new tree at 660 that is semantically equivalent but has an optimized execution strategy. At this point, at 670, the expression tree can be compiled, e.g., using the LINQ libraries to turn expression tree into executable code, and executed at 680. It is note that, as in the default case, no query execution engine is required, i.e., the presently described implementation of the invention need only provide the specific set of functions that represent the physical operators for query execution (e.g., index-lookup join, indexed-scan, etc.), such that execution itself happens by simply executing the compiled execution tree at 680.

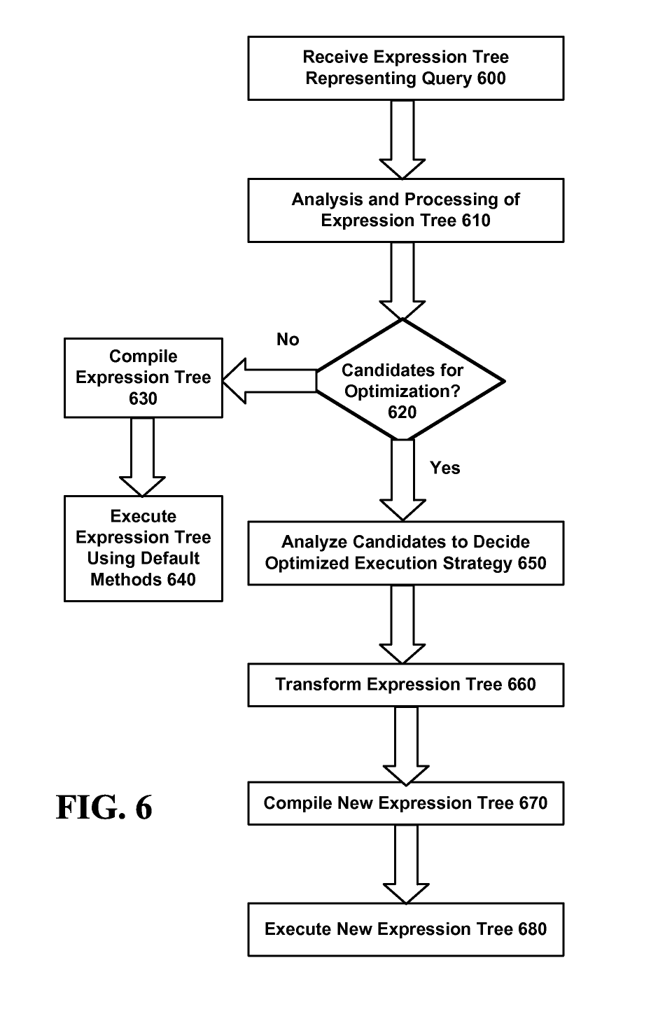

The exemplary non-limiting block diagram of FIG. 7 represents various compile-time and run-time components that interact during query execution against an in-memory data structure in accordance with the presently described DataSet implementation of the invention.

Both the compile-time elements 700 and run-time elements 710 are illustrated on opposite sides of FIG. 7. At 720, an exemplary LINQ query is received in the language of the host program. After compilation, at 730, the LINQ query is represented as an expression tree. As illustrated, the tree has nodes, and paths or transitions adjoining nodes. Then, on run-time side 710, at 7340, the command to execute the query is received causing the expression tree to be passed to the lightweight query processor of the invention. At 750, the expression tree is analyzed to determine if there are any candidates for optimization, whereby one or more designated nodes of the tree undergo expression analysis. At 760, if appropriate candidates are found, then the tree is potentially transformed according to a more optimal execution path, whereby the transformed tree is semantically equivalent to the expression tree defined by the compile-time compilation. The resulting tree, which may or may not have changes as a result of the transformation step, is then passed to the run-time code generator that generates executable code for the resulting tree at 770.

As noted above, in the presently described, non-limiting LINQ implementation of the lightweight query processing of the invention, involvement of the query processor includes custom DataSet-specific operators being called if the query processor performs any replacement of nodes in the expression tree. Once the executable code is generated, however, no query processor need be involved any more.

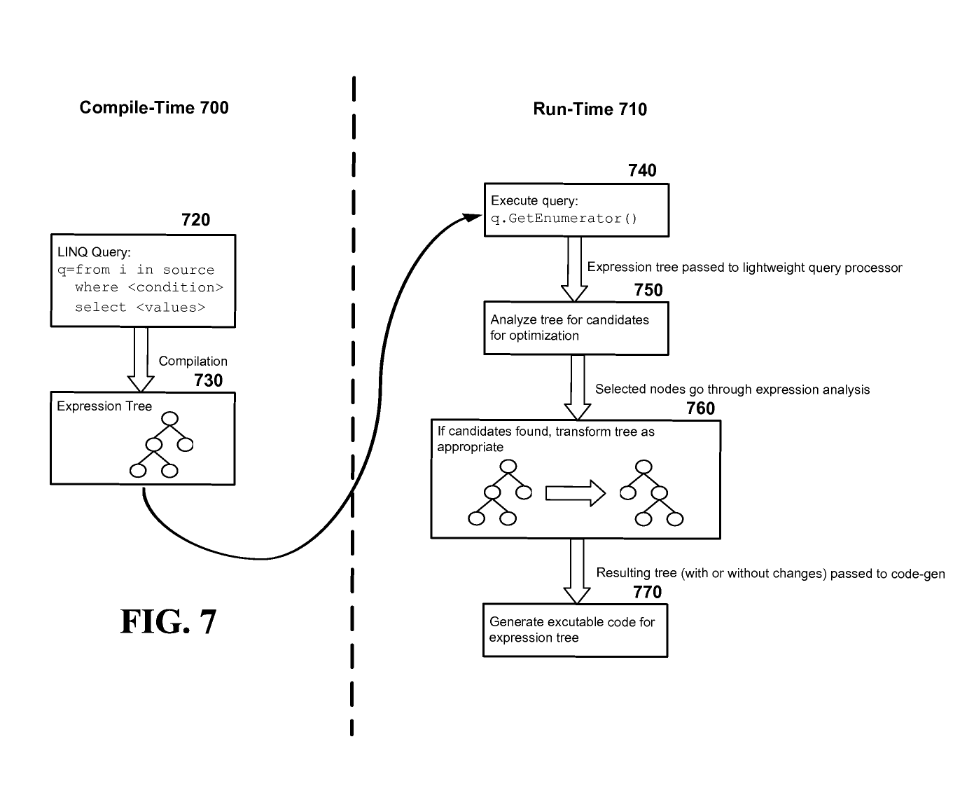

To illustrate this concept of not having a query execution engine and executing code directly in the presently described LINQ implementation, the following trivial optimization example may be considered. Given a DataTable “customers” that has CompanyName and State columns (same as the previous example), a query to list all of the companies in the state of Washington may be represented by the exemplary pseudo-code 800 of FIG. 8A.

In absence of any optimization pass, pseudo-code 800 is translated by the compiler to the exemplary pseudo-code 810 of FIG. 8B. As an alternative to the default implementation of FIG. 8B, however, if instead an expression tree is generated and optimized according to the present invention, then assuming, for instance, that there was an index present for the State column, the DataSet lightweight query processor in accordance with the invention generates an expression tree representation equivalent to the exemplary pseudo-code 820 of FIG. 8C.

The difference between the Where expression of pseudo-code 810 and the DSWhere expression of pseudo-code 820 is that Where is the standard query operator that performs a less than optimal sequential scan/test, whereas DSWhere is the custom DataSet-specific method that will perform a more optimal index-range scan.

In addition to showing the difference between executing query code directly with default LINQ mechanism and executing query code according to the lightweight query processing of the invention, FIGS. 8A to 8C represent the processing stages for a query. FIG. 8A illustrates code 800, which a programmer actually writes. The compiler (e.g., the C# compiler) will then translate code 800 into code 810 of FIG. 8B (conceptually, not syntactically), and then the LINQ/DataSet optimizer will translate code 810 (conceptually, again) to code 820 of FIG. 8C and execute code 820 assuming that there is an index that favors this translation.

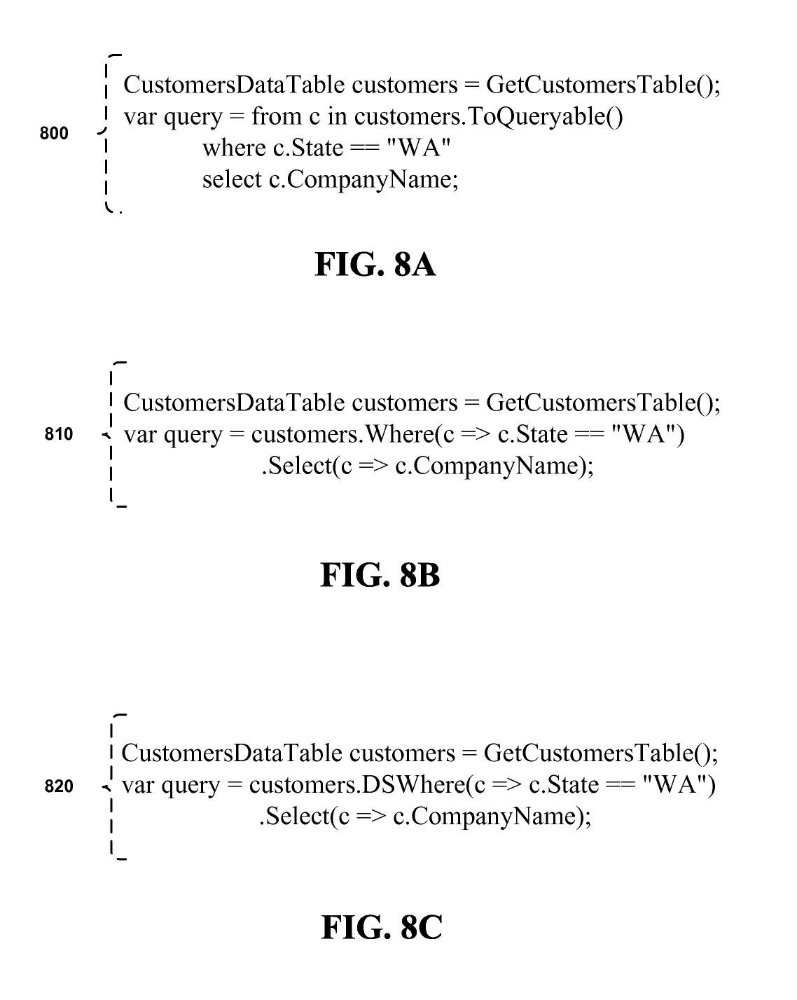

As mentioned, the invention provides lightweight query processing for in-memory data structures where memory access is fast. Thus, the benefits of the invention can be realized where heavy analysis is performed against the in-memory data structures, such as DataSet. For instance, as shown in FIG. 9, a typical performance curve (time v. number of rows in data set) 910 is illustrated. In this regard, query processing time generally increases as correlated to the number of rows. For the lightweight query processing of the invention, the performance curve 900, in contrast, involves an upfront cost C1 in terms of time, but the benefits of such optimization realize very quickly as the number of rows increase, whereby, for hypothetical example, anytime N2 or more rows exist in cache, there is a benefit to optimizing in accordance with the lightweight query processing techniques of the invention.

In other optional embodiments of the invention, one or more bail out points can be introduced into the lightweight query processing in order to further optimize average query processing times. A “bail out” point during the optimization analysis, such as optimization analysis 750 of FIG. 7, is point where the optimization process ceases if some threshold probability is reached where optimization is unlikely to benefit the received query. For instance, as a threshold determination, an immediate pass can be performed to determine whether any part of the expression tree is even of a type that can benefit from optimization over the default implementation. As an example, if it is immediately determined that only 10 rows are in the cache, the query is unlikely to receive any observable benefit from optimization. In such case, the lightweight query processing of the invention ceases performing its optimization analysis, and executes the default compilation and execution methods on the expression tree instead.

The benefits of bail out point(s) in accordance with the lightweight query processing of the invention can also be observed in FIG. 9. Considering the situation where the lightweight query processing is performed up to a bail-out point, and the algorithm opts to bail out, there is a pre-defined bail out cost C2 associated with the time until the algorithm opts to bail out. Where bail out has taken place, therefore, the performance curve appears like curve 920, in the shape of curve 910, but time-shifted by the bail out cost C2. This has the effect of shifting the point N2 to N1, i.e., including one or more bail out points shifts the point where query processing will benefit from optimization in favor of optimization, and simultaneously, even where the bail out cost C2 is incurred, implicating performance curve 920, the number of rows will be less than N1, meaning that the time to execute the query will still be very fast. In this sense, adding one or more optional bail outs in accordance with the lightweight query processing of the invention has the effect of avoiding a bad execution path for a query, as opposed to necessarily in all instances, selecting the absolute fastest path.

### Language Integrated Query Support

As discussed in detail above, in exemplary, non-limiting embodiments, lightweight query processing is provided in connection with querying over in-memory data structures with language integrated query (LINQ) support. For some additional context, the present section provides some supplemental context for the LINQ framework. In this regard, LINQ describes a general purpose set of query facilities to the .NET Framework that apply to all sources of information, not just relational or XML data.

The term language integrated query indicates that querying is provided as an integrated feature of the developer's primary programming languages, e.g., C#, Visual Basic, etc. LINQ allows query expressions to benefit from the rich metadata, compile-time syntax checking, static typing and IntelliSense that was previously available only to imperative code. LINQ also allows a single general purpose declarative query facility to be applied to all in-memory information, not just information from external sources.

.NET LINQ defines a set of general purpose standard query operators that allow traversal, filter, and projection operations to be expressed in a direct yet declarative way in any .NET-based programming language. The standard query operators allow queries to be applied to any IEnumerable<T>-based information source. LINQ allows third parties to augment the set of standard query operators with new domain-specific operators that are appropriate for the target domain or technology. Third parties are also free to replace the standard query operators with their own implementations that provide additional services such as remote evaluation, query translation, optimization, etc. By adhering to the conventions of the LINQ pattern, such implementations enjoy the same language integration and tool support as the standard query operators.

For instance, the extensibility of the query architecture of LINQ enables implementations that work over both XML and SQL data. The query operators over XML (LINQ to XML) use an efficient, easy-to-use in-memory XML facility to provide XPath/XQuery functionality in the host programming language. The query operators over relational data (LINQ to SQL) build on the integration of SQL-based schema definitions into the common language run-time (CLR) type system. This integration provides strong typing over relational data while retaining the expressive power of the relational model and the performance of query evaluation directly in the underlying store.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for optimizing querying of in-memory data structures in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes. Data can be retrieved or consolidated from anywhere for local analysis in in-memory data structures, and thus the techniques for optimizing querying of in-memory data structures in accordance with the present invention can be applied with great efficacy in those environments.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for optimizing querying of in-memory data structures in accordance with the invention.

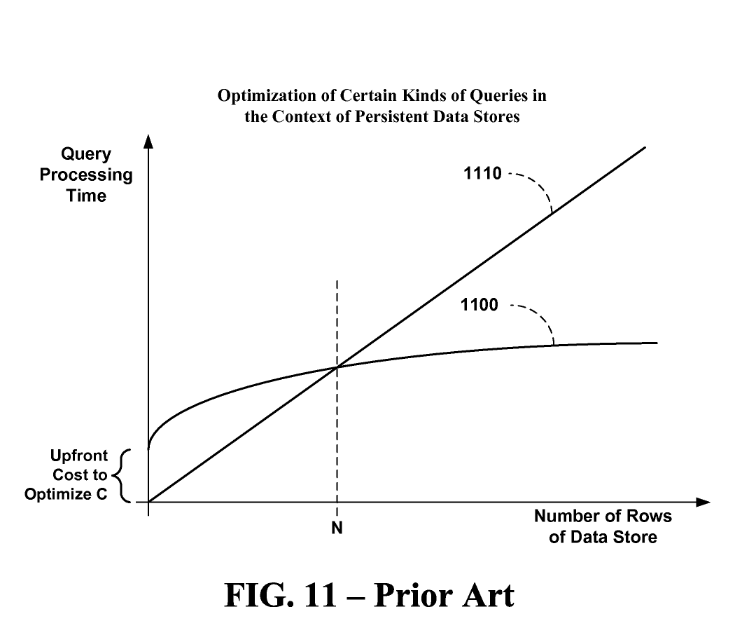

FIG. 12 provides a schematic diagram of an exemplary networked or distributed computing environment. The distributed computing environment comprises computing objects 1210a, 1210b, etc. and computing objects or devices 1220a, 1220b, 1220c, 1220d, 1220e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1240. This network may itself comprise other computing objects and computing devices that provide services to the system of FIG. 12, and may itself represent multiple interconnected networks. In accordance with an aspect of the invention, each object 1210a, 1210b, etc. or 1220a, 1220b, 1220c, 1220d, 1220e, etc. may contain an application that might make use of an API, or other object, software, firmware and/or hardware, suitable for use with the systems and methods for optimizing querying of in-memory data structures in accordance with the invention.

It can also be appreciated that an object, such as 1220c, may be hosted on another computing device 1210a, 1210b, etc. or 1220a, 1220b, 1220c, 1220d, 1220e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to optimizations for querying of in-memory data structures according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 12, as an example, computers 1220a, 1220b, 1220c, 1220d, 1220e, etc. can be thought of as clients and computers 1210a, 1210b, etc. can be thought of as servers where servers 1210a, 1210b, etc. maintain the data that is then replicated to client computers 1220a, 1220b, 1220c, 1220d, 1220e, etc., although any computer can be considered a client, a server, or both, depending on the circumstances. Any of these computing devices may be processing data or requesting services or tasks that may implicate the need for optimizing queries against in-memory data structures in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for optimizing querying of in-memory data structures in accordance with the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 12 illustrates an exemplary networked or distributed environment, with server(s) in communication with client computer (s) via a network/bus, in which the present invention may be employed. In more detail, a number of servers 1210a, 1210b, etc. are interconnected via a communications network/bus 1240, which may be a LAN, WAN, intranet, GSM network, the Internet, etc., with a number of client or remote computing devices 1220a, 1220b, 1220c, 1220d, 1220e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to optimize querying of in-memory data structures.

In a network environment in which the communications network/bus 1240 is the Internet, for example, the servers 1210a, 1210b, etc. can be Web servers with which the clients 1220a, 1220b, 1220c, 1220d, 1220e, etc. communicate via any of a number of known protocols such as HTTP. Servers 1210a, 1210b, etc. may also serve as clients 1220a, 1220b, 1220c, 1220d, 1220e, etc., as may be characteristic of a distributed computing environment.

As mentioned, communications may be wired or wireless, or a combination, where appropriate. Client devices 1220a, 1220b, 1220c, 1220d, 1220e, etc. may or may not communicate via communications network/bus 14, and may have independent communications associated therewith. For example, in the case of a TV or VCR, there may or may not be a networked aspect to the control thereof. Each client computer 1220a, 1220b, 1220c, 1220d, 1220e, etc. and server computer 1210a, 1210b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1210a, 1210b, 1220a, 1220b, 1220c, 1220d, 1220e, etc. may be responsible for the maintenance and updating of a database 1230 or other storage element, such as a database or memory 1230 for storing data processed or saved according to the invention. Thus, the present invention can be utilized in a computer network environment having client computers 1220a, 1220b, 1220c, 1220d, 1220e, etc. that can access and interact with a computer network/bus 1240 and server computers 1210a, 1210b, etc. that may interact with client computers 1220a, 1220b, 1220c, 1220d, 1220e, etc. and other like devices, and databases 1230.

### Exemplary Computing Device

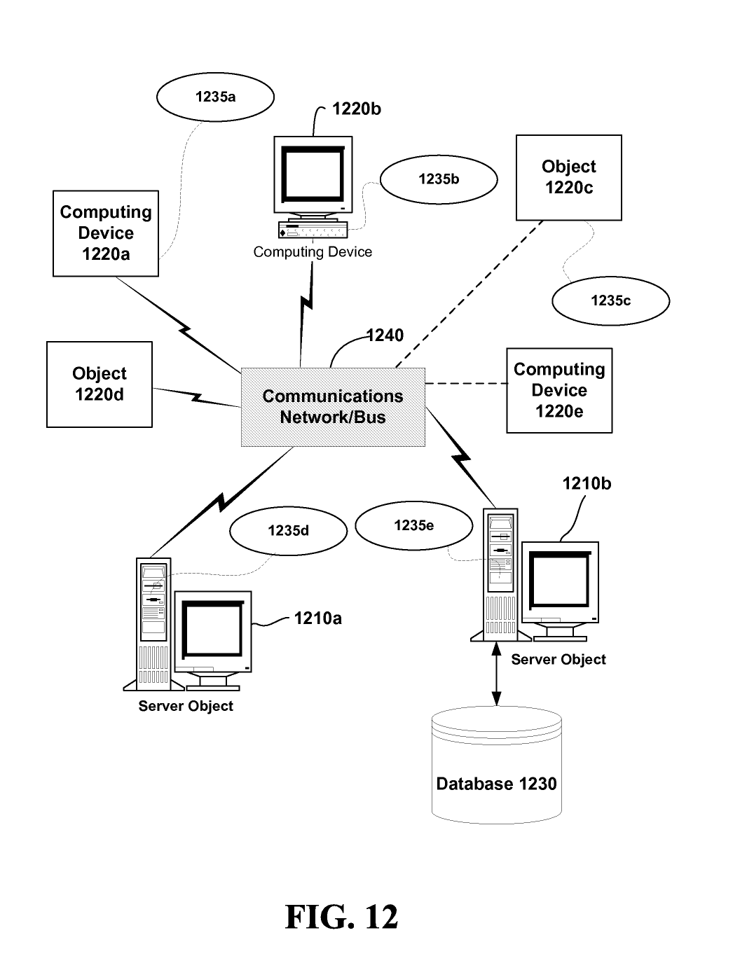

As mentioned, the invention applies to any device wherein it may be desirable to optimize querying of in-memory data structures. It should be understood, therefore, that handheld, portable and other computing devices and computing objects of all kinds are contemplated for use in connection with the present invention, i.e., anywhere that a device may receive a query intended for execution against in-memory data structures or otherwise receive, process or store queryable data. Accordingly, the below general purpose remote computer described below in FIG. 13 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 13 thus illustrates an example of a suitable computing system environment 1300a in which the invention may be implemented, although as made clear above, the computing system environment 1300a is only one example of a suitable computing environment for a media device and is not intended to suggest any limitation as to the scope of use or functionality of the invention. Neither should the computing environment 1300a be interpreted as having any dependency or requirement relating to any one or combination of components illustrated in the exemplary operating environment 1300a.

With reference to FIG. 13, an exemplary remote device for implementing the invention includes a general purpose computing device in the form of a computer 1310a. Components of computer 1310a may include, but are not limited to, a processing unit 1320a, a system memory 1330a, and a system bus 1321a that couples various system components including the system memory to the processing unit 1320a. The system bus 1321a may be any of several types of bus structures including a memory bus or memory controller, a peripheral bus, and a local bus using any of a variety of bus architectures.

Computer 1310a typically includes a variety of computer readable media. Computer readable media can be any available media that can be accessed by computer 1310a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1310a. Communication media typically embodies computer readable instructions, data structures, program modules or other data in a modulated data signal such as a carrier wave or other transport mechanism and includes any information delivery media.

The system memory 1330a may include computer storage media in the form of volatile and/or nonvolatile memory such as read only memory (ROM) and/or random access memory (RAM). A basic input/output system (BIOS), containing the basic routines that help to transfer information between elements within computer 1310a, such as during start-up, may be stored in memory 1330a. Memory 1330a typically also contains data and/or program modules that are immediately accessible to and/or presently being operated on by processing unit 1320a. By way of example, and not limitation, memory 1330a may also include an operating system, application programs, other program modules, and program data.

The computer 1310a may also include other removable/non-removable, volatile/nonvolatile computer storage media. For example, computer 1310a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1321a through a non-removable memory interface such as an interface, and a magnetic disk drive or optical disk drive is typically connected to the system bus 1321a by a removable memory interface, such as an interface.

A user may enter commands and information into the computer 1310a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1320a through user input 1340a and associated interface(s) that are coupled to the system bus 1321a, but may be connected by other interface and bus structures, such as a parallel port, game port or a universal serial bus (USB). A graphics subsystem may also be connected to the system bus 1321a. A monitor or other type of display device is also connected to the system bus 1321a via an interface, such as output interface 1350a, which may in turn communicate with video memory. In addition to a monitor, computers may also include other peripheral output devices such as speakers and a printer, which may be connected through output interface 1350a.

The computer 1310a may operate in a networked or distributed environment using logical connections to one or more other remote computers, such as remote computer 1370a, which may in turn have media capabilities different from device 1310a. The remote computer 1370a may be a personal computer, a server, a router, a network PC, a peer device or other common network node, or any other remote media consumption or transmission device, and may include any or all of the elements described above relative to the computer 1310a. The logical connections depicted in FIG. 13 include a network 1371a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1310a is connected to the LAN 1371a through a network interface or adapter. When used in a WAN networking environment, the computer 1310a typically includes a communications component, such as a modem, or other means for establishing communications over the WAN, such as the Internet. A communications component, such as a modem, which may be internal or external, may be connected to the system bus 1321a via the user input interface of input 1340a, or other appropriate mechanism. In a networked environment, program modules depicted relative to the computer 1310a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for optimizing querying of in-memory data structures in accordance with the invention may be included in, supported in or accessed via all of the languages and services enabled by managed code, such as .NET code, and in other distributed computing frameworks as well.

### Exemplary Interface Implementations

For any exchange and sharing of data among multiple computers, such as when data is consolidated to an in-memory data structure, when a query is executed, when query results are returned, etc. according to the techniques of the invention, there are interfaces for handling the various operations on each computer that can be implemented in hardware and/or software and which operate to receive, send and/or process the data in some fashion, according to the relevant applications and services being requested or provided. To the extent that one or more interface objects may be provided to achieve or implement any portion of the systems and methods for optimizing querying of in-memory data structures in accordance with the invention, the invention is intended to encompass all such embodiments, and thus a general description of the kinds of interfaces that might be provided or utilized when implementing or carrying out the invention from an interface standpoint follows.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

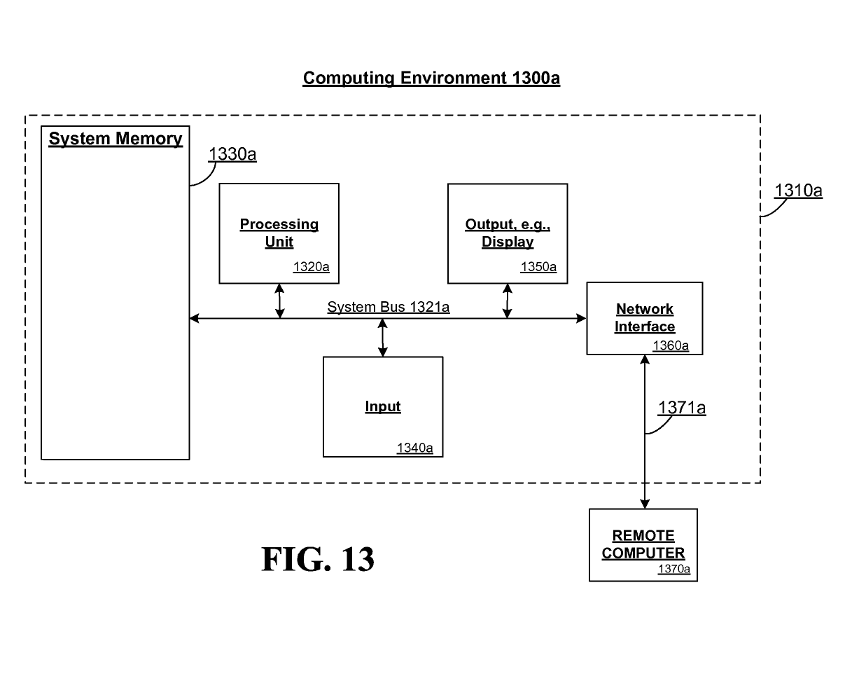

Notionally, a programming interface may be viewed generically, as shown in FIG. 14A or FIG. 14B. FIG. 14A illustrates an interface Interface1 as a conduit through which first and second code segments communicate. FIG. 14B illustrates an interface as comprising interface objects I1 and I2 (which may or may not be part of the first and second code segments), which enable first and second code segments of a system to communicate via medium M. In the view of FIG. 14B, one may consider interface objects I1 and I2 as separate interfaces of the same system and one may also consider that objects I1 and I2 plus medium M comprise the interface. Although FIGS. 14A and 14B show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing detailed description of the invention. There are, however, other ways to implement a programming interface, and, unless expressly excluded, these too are intended to be encompassed by the claims set forth at the end of this specification. Such other ways may appear to be more sophisticated or complex than the simplistic view of FIGS. 14A and 14B, but they nonetheless perform a similar function to accomplish the same overall result. We will now briefly describe some illustrative alternative implementations of a programming interface.

### A. Factoring

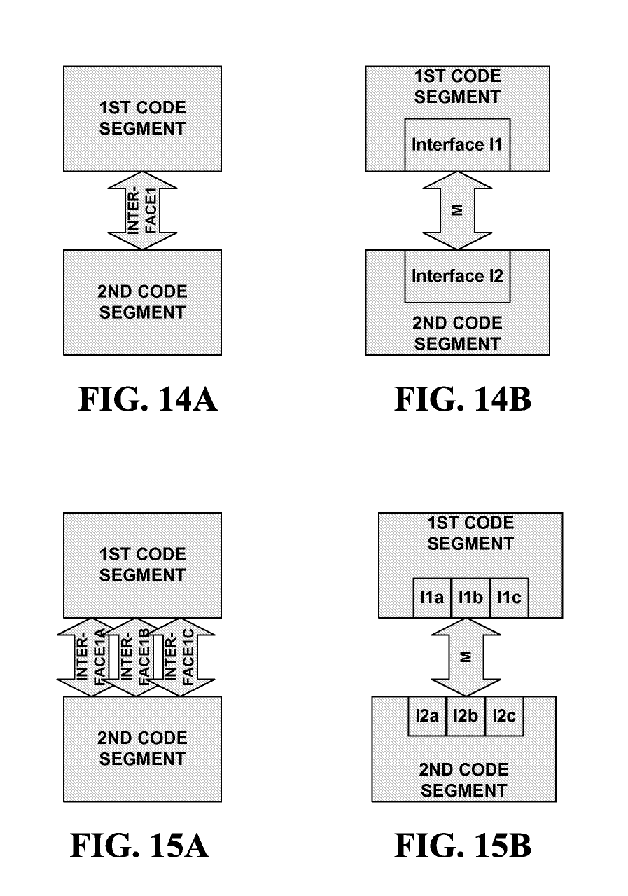

A communication from one code segment to another may be accomplished indirectly by breaking the communication into multiple discrete communications. This is depicted schematically in FIGS. 15A and 15B. As shown, some interfaces can be described in terms of divisible sets of functionality. Thus, the interface functionality of FIGS. 14A and 14B may be factored to achieve the same result, just as one may mathematically provide 24, or 2 times 2 time 3 times 2. Accordingly, as illustrated in FIG. 15A, the function provided by interface Interface I may be subdivided to convert the communications of the interface into multiple interfaces Interface 1A, Interface 1B, Interface 1C, etc. while achieving the same result. As illustrated in FIG. 15B, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1^{st} code segment need not match the number of interfaces included with the 2^{nd} code segment. In either of the cases of FIGS. 15A and 15B, the functional spirit of interfaces Interface1 and I1 remain the same as with FIGS. 14A and 14B, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

### B. Redefinition

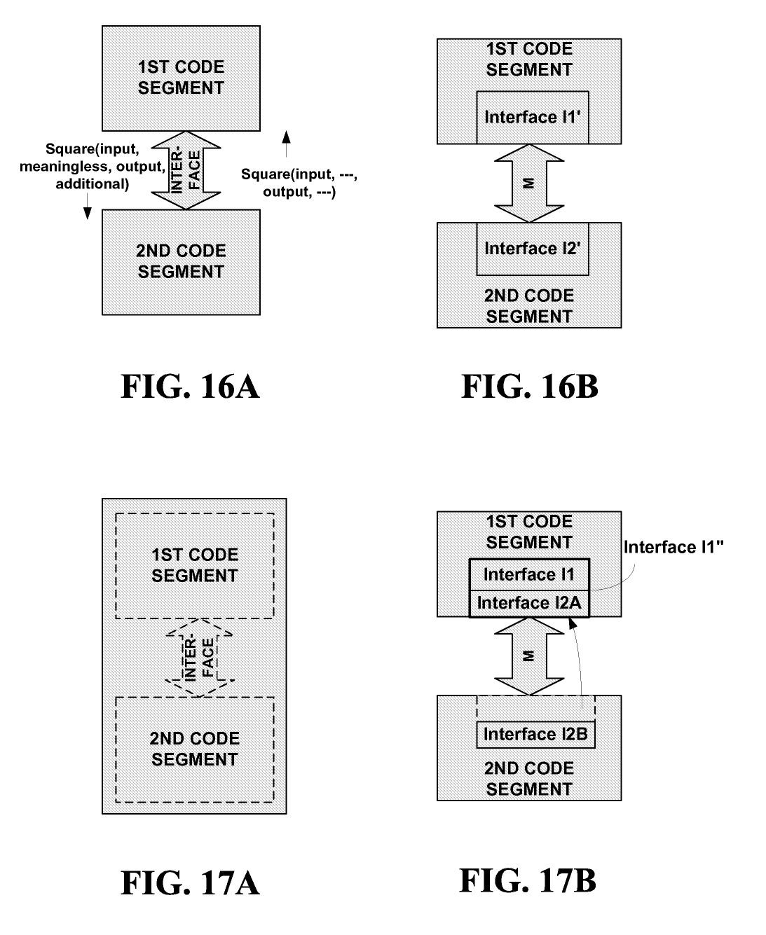

In some cases, it may be possible to ignore, add or redefine certain aspects (e.g., parameters) of a programming interface while still accomplishing the intended result. This is illustrated in FIGS. 16A and 16B. For example, assume interface Interface1 of FIG. 14A includes a function call Square(input, precision, output), a call that includes three parameters, input, precision and output, and which is issued from the 1^{st} Code Segment to the 2^{nd} Code Segment., If the middle parameter precision is of no concern in a given scenario, as shown in FIG. 16A, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 16B, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, that are not needed for some purpose, and so they may be ignored or redefined, or processed elsewhere for other purposes.

### C. Inline Coding

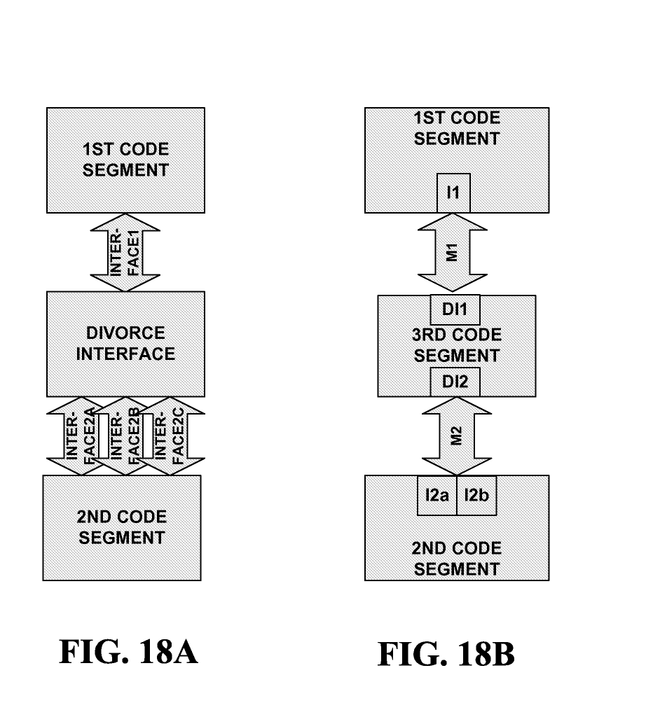

It may also be feasible to merge some or all of the functionality of two separate code modules such that the “interface” between them changes form. For example, the functionality of FIGS. 14A and 14B may be converted to the functionality of FIGS. 17A and 17B, respectively. In FIG. 17A, the previous 1^{st} and 2^{nd} Code Segments of FIG. 14A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 17B, part (or all) of interface I2 from FIG. 14B may be written inline into interface I1 to form interface I1″. As illustrated, interface 12 is divided into I2a and I2b, and interface portion I2a has been coded in-line with interface I1 to form interface I1″. For a concrete example, consider that the interface I1 from FIG. 14B performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

### D. Divorce

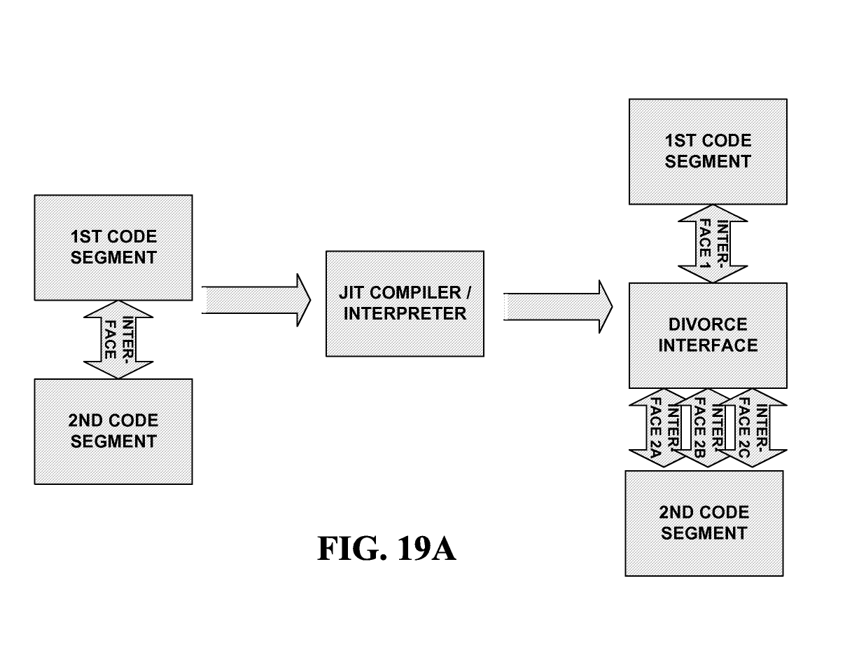

A communication from one code segment to another may be accomplished indirectly by breaking the communication into multiple discrete communications. This is depicted schematically in FIGS. 18A and 18B. As shown in FIG. 18A, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface 1 protocol, but then the operating system is changed to use a different interface, in this case interfaces Interface2A, Interface2B and Interface2C. The point is that the original interface used by the 2^{nd} Code Segment is changed such that it is no longer compatible with the interface used by the 1^{st} Code Segment, and so an intermediary is used to make the old and new interfaces compatible. Similarly, as shown in FIG. 18B, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 14B to a new operating system, while providing the same or similar functional result.

### E. Rewriting

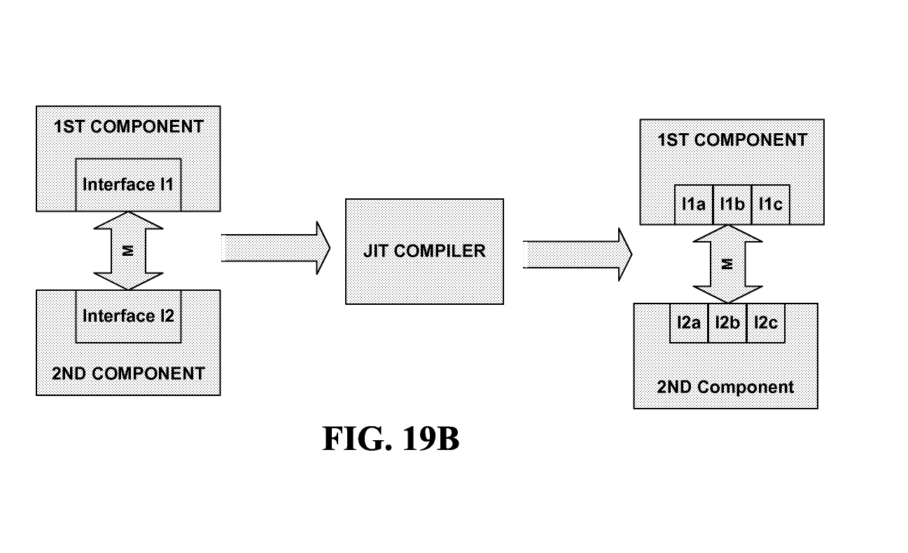

Yet another possible variant is to dynamically rewrite the code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1^{st} Code Segment to the 2^{nd} Code Segment, i.e., to conform them to a different interface as may be required by the 2^{nd} Code Segment (either the original or a different 2^{nd} Code Segment). This is depicted in FIGS. 19A and 19B. As can be seen in FIG. 19A, this approach is similar to the Divorce scenario described above. It might be done, e.g., where an installed base of applications are designed to communicate with an operating system in accordance with an Interface 1 protocol, but then the operating system is changed to use a different interface. The JIT Compiler could be used to conform the communications on the fly from the installed-base applications to the new interface of the operating system. As depicted in FIG. 19B, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 14A and 14B. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

There are multiple ways of implementing the present invention, e.g., an appropriate API, tool kit, driver code, operating system, control, standalone or downloadable software object, etc. which enables applications and services to use the systems and methods for optimizing querying of in-memory data structures in accordance with the invention. The invention contemplates the use of the invention from the standpoint of an API (or other software object), as well as from a software or hardware object that receives a downloaded program in accordance with the invention, whether pre-compiled or performed at run-time. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to optimize querying of in-memory data structures. For instance, the lightweight query processing of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize techniques for optimizing querying of in-memory data structures of the present invention, e.g., through the use of a data processing API, CLR component, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

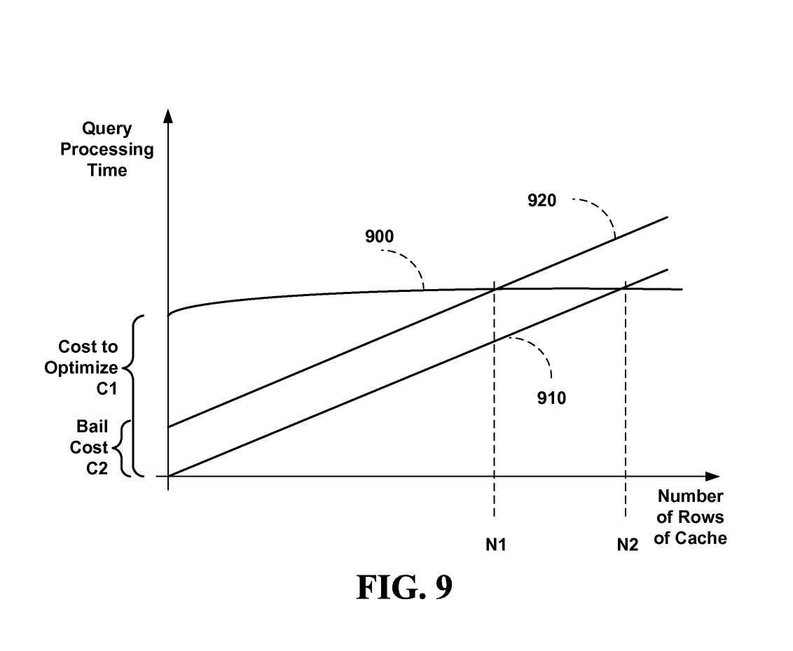

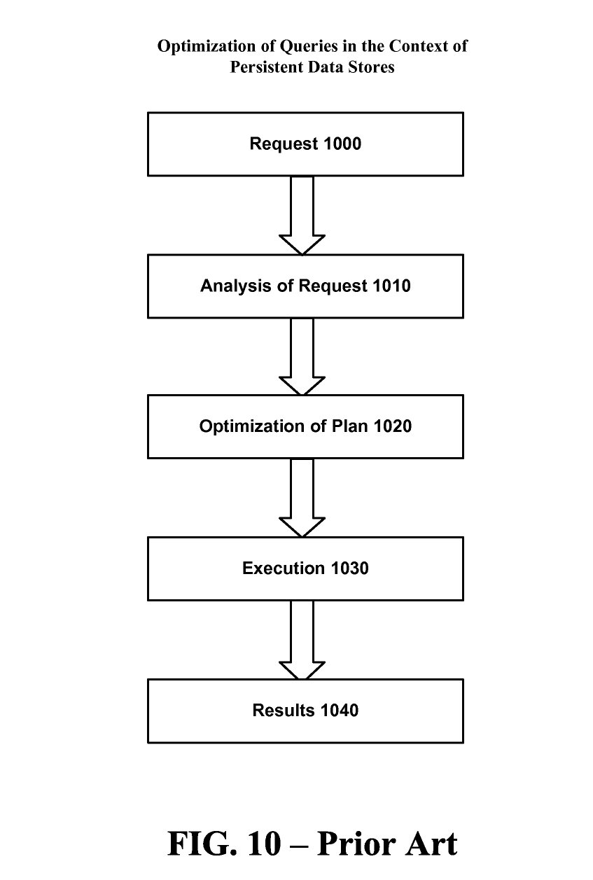

In view of the exemplary systems described supra, methodologies that may be implemented in accordance with the disclosed subject matter will be better appreciated with reference to the flowcharts of FIGS. 4, 6, 7 and 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for optimizing querying of in-memory data structures. Also, the term “query” as used herein may refer to the code, or query language, in which the query is formed, object code that represents an executable query, one or more tree expressions stored in one or more data structures that represents the query, or any other equivalent representation of the query code. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for processing a query to be executed against an in-memory data structure, comprising:
receiving a query to be executed against an in-memory data structure; and
determining whether to optimize the query with at least one optimization algorithm according to at least one criterion for determining efficiency of query execution against the in-memory data structure.

2. The method of claim 1, further including:
optimizing the query to form an optimized query according to the at least one optimization algorithm if said determining determines that the query is executable faster by performing the at least one optimization algorithm on the query; and
executing the optimized query.

3. The method of claim 2, wherein said determining includes determining whether to optimize the query according to at least one criterion that determines time of execution relative to a time associated with a default execution of the query without said optimizing.

4. The method of claim 1, further comprising:
executing the query without the at least one optimization algorithm if said determining determines that the query will not benefit from the at least one optimization algorithm.

5. The method of claim 1, further comprising:
if said determining determines that the query meets a first bail out condition, executing the query without performing the at least one optimization algorithm,
wherein said determining includes determining whether the first bail-out condition is present in the query.

6. The method of claim 5, further comprising:
if the query does not meet the first bail out condition, executing the query without the at least one optimization algorithm if said determining determines that the query meets a second bail out condition,
wherein said determining includes determining whether the second bail-out condition is present in the query.

7. The method of claim 1, wherein said determining includes determining whether to optimize the query based on at least one of (A) a determination of a complexity of the query, (B) whether at least one auxiliary data structure is available for efficient query execution or (C) whether one or portions of the query match at least one pre-defined query pattern.

8. The method of claim 1, wherein said determining includes determining whether to optimize the query with at least one index associated with the in-memory data structure.

9. The method of claim 1, wherein said receiving includes receiving the query to be executed against a DataSet data structure.

10. The method of claim 9, wherein said receiving includes receiving a language integrated query (LINQ) query to be executed against the in-memory data structure.

11. An application programming interface comprising computer executable modules for performing the method of claim 1.

12. A computing device comprising means for performing the method of claim 1.

13. A query processing framework for processing queries over in-memory data structures, comprising:
a run-time component including a query processor that receives at run-time at least one tree expression data structure representing at least one query to be executed against at least one in-memory data structure and evaluates whether the at least one tree expression data structure is transformable to at least one semantically equivalent tree expression data structure that executes the at least one query more efficiently than a default execution for the at least one tree expression data structure.

14. The query processing framework of claim 13, further comprising:
a compiler for compiling program instructions including the at least one query to be executed against the at least one in-memory data structure, wherein said compiler generates the at least one tree expression data structure representing the at least one query.

15. The query processing framework of claim 13, wherein the query processor transforms the at least one tree expression data structure to the at least one semantically equivalent tree expression data structure when it is evaluated that execution of the at least one semantically equivalent tree expression data structure is more efficient.

16. The query processing framework of claim 13, wherein the at least one in-memory data structure is at least one DataSet, and the at least one query is at least one LINQ query.

17. The query processing framework of claim 13, wherein the query processor evaluates whether the at least one tree expression data structure matches at least one bail out condition, wherein the run-time component executes the at least one tree expression data structure according to the default execution.

18. A computer readable medium comprising computer executable instructions for performing the method of:
retrieving data from a plurality of data sources to generate at least one DataSet;
generating a query object to be executed against the at least one DataSet; and
transmitting the query object to a lightweight query processor that determines whether at least one optimization applies to transform the at least one query prior to execution against the at least one DataSet.

19. The computer readable medium of claim 18, wherein the at least one DataSet supports both regular DataSet classes and typed-DataSet classes.

20. The computer readable medium of claim 18, wherein said generating includes generating a LINQ query object that includes at least one query operator and said transmitting includes transmitting the LINQ query object to the lightweight processor that determines whether the at least one optimization applies to transform the at least one query operator prior to execution against the at least one DataSet.
